(19) United States
(12) Patent Application Publication
(10) Pub. No.: US 2012/0043822 A1
(43) Pub. Date: Feb. 23, 2012

(54) MODULAR ELECTRICAL ACCUMULATOR UNIT

(76) Inventors: Josh C. Swenson, Rockford, IL (US); Vietson M. Nguyen, Rockford, IL (US)

(21) Appl. No.: 12/859,386

(22) Filed: Aug. 19, 2010

(51) Int. Cl. H02J 7/34

(52) U.S. Cl. 307/82

(57) ABSTRACT

A modular electrical accumulator unit includes multiple electrical accumulator unit modules, which are operated in conjunction with each other to form a single electrical accumulator unit.

### BACKGROUND

The present application is directed toward power generation systems, and more particularly toward a power generation system using an electrical accumulator unit.

In order to provide power to electrical systems many vehicles, such as military aircraft, feature an on-board generator which converts rotational movement within the engines to electrical power using known power generation techniques. The generated electrical power is used to power on-board electrical components such as flight controls, sensors, or weapons controls. During standard operations, such a system has an electrical load which normally draws power at a certain level. When some on-board electrical systems, such as weapons systems, are activated a temporary elevated load spike occurs.

In order to compensate for the temporary load spike, a generator is typically used which is rated at least as high as the highest anticipated power spike. This ensures that adequate power can be provided to the on-board electrical systems at all times, including during elevated load spikes. In a typical power generation system, the physical size of the generator is directly related to the power rating of the generator. Consequently, use of a higher rated generator to account for high load spikes results in a heavy generator.

### SUMMARY

A modular electrical accumulator unit has multiple electrical accumulator unit modules. Each electrical accumulator unit module has an energy storage component, a power converter electrically coupled to the energy storage component, a pair of electrical connectors for connecting the modules to a power bus, and a power switch capable of isolating the module from the power bus. The electrical accumulator unit also includes an electrical controller that is coupled to each of the power switches, thereby allowing the electrical controller to control a connection between each of the modules and the power bus.

A method for operating an aircraft power system includes the steps of: generating power with a three-phase generator, converting the power into DC power format, providing the DC power to a DC power bus, the DC power bus providing power to a variable load and to a plurality of electrical accumulator unit modules, and controlling the plurality of electrical accumulator unit modules using a dedicated electrical accumulator unit controller.

These and other features of the present invention can be best understood from the following specification and drawings, the following of which is a brief description.

### BRIEF DESCRIPTION OF THE DRAWINGS

FIG. 1 illustrates a sample aircraft having an on-board power generation system.

FIG. 2 schematically illustrates an aircraft power generation system including an electrical accumulator unit.

FIG. 3 schematically illustrates an example modular electrical accumulator unit.

FIG. 4 schematically illustrates another example modular electrical accumulator unit.

FIG. 5 illustrates a flow chart of an example method for operating a modular electrical accumulator unit.

### DETAILED DESCRIPTION

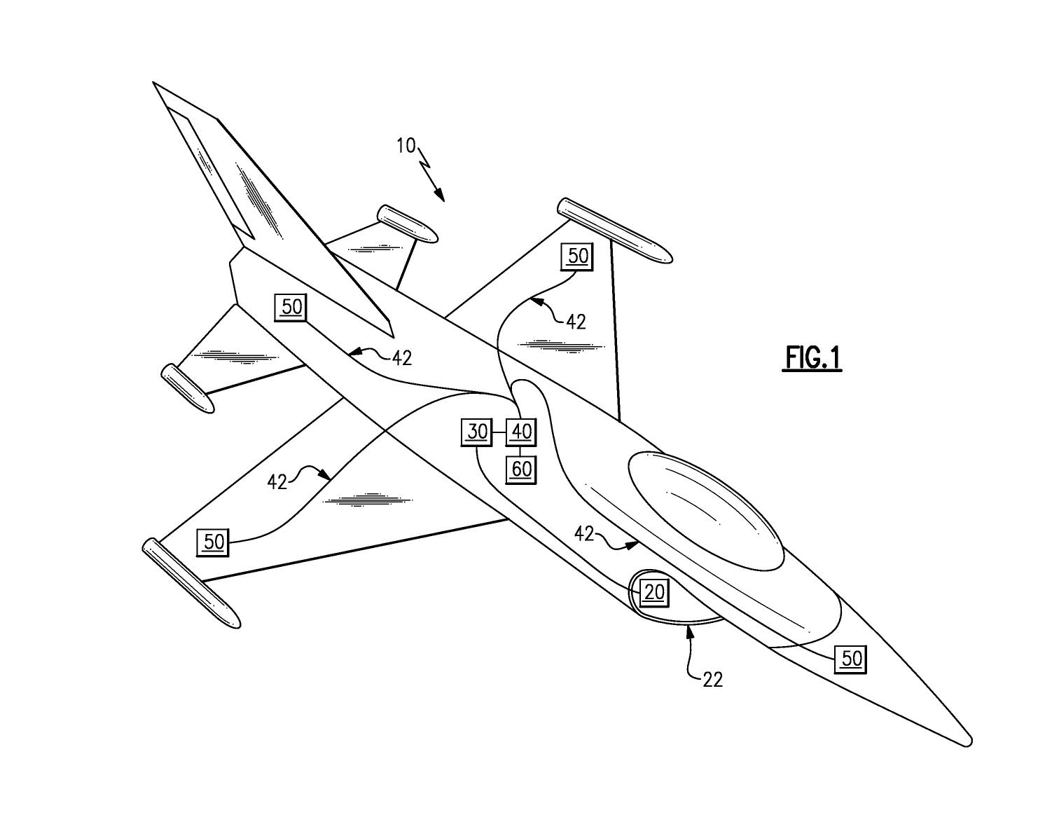

FIG. 1 schematically illustrates a sample aircraft 10 having an on-board power generation system. A generator 20 converts rotational motion within an engine 22 into electrical power using known power generation techniques. The generator 20 is electrically coupled to a rectifier 30. The rectifier 30 converts the power generated in the generator 20 (typically three-phase power) into a form usable by on-board electronics 50 (typically DC power). The rectifier 30 is electrically coupled to a power bus 40 which supplies power to the on-board electronics 50 through power supply lines 42. Additionally connected to the power bus 40, is an electrical accumulator unit 60, which can store excess power generated by the generator 20 when the load created by the on-board electronics 50 is low, and reinsert that power into the power system when the load created by the on-board electronics 50 undergoes a high load spike.

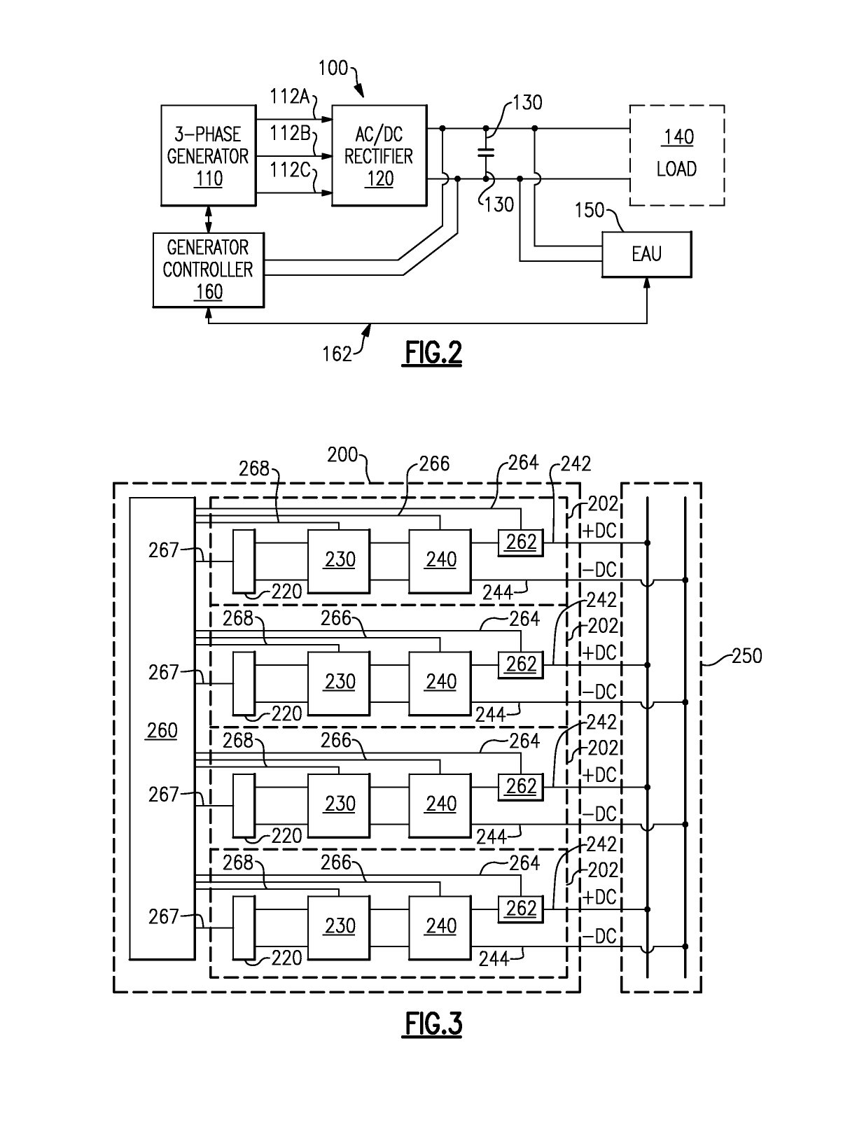

FIG. 2 schematically illustrates a power generation system 100 described with regards to FIG. 1. A three phase generator 110 is connected to an AC/DC rectifier 120 via three phase outputs 112A, 112B, 112C. The three phase generator 110 may also be referred to as generator 110. The AC/DC rectifier 120 converts the generated three phase power into DC power, and outputs the DC power to a power bus 130. Connected to the DC power bus 130 is a variable load 140. The variable load 140 may represent a variable number and size of electrical loads that can change over time and/or be selectively added, removed, or modified. Additionally connected to the DC power bus 130 is an electrical accumulator unit 150. The three phase generator 110, AC/DC rectifier 120, DC power bus 130, variable load 140, and electrical accumulator unit 150 represent embodiments of the generator 20, rectifier 30, power bus 40, the load created by the on-board electronics 50, and electrical accumulator unit 60 of FIG. 1 respectively. A generator controller 160 (also referred to as controller 160) is connected to both the electrical accumulator unit 150 (via link 162) and the three phase generator 110, and provides control signals for both. The generator controller 160 is also connected to the output of the AC/DC rectifier 120 via power sensors, and is capable of detecting the power output of the AC/DC rectifier 120 and the power demands of the variable load 140. Alternately, the electrical accumulator unit 150 can be controlled via an electrical accumulator unit controller independently of the controller 160.

In the example power generation system 100 of FIG. 2, the generator 110 generates power at its maximum rating and the variable load 140 often uses less than all of the generated power. The excess power in this case is siphoned off by the electrical accumulator unit 150, which stores the excess power in a power storage component such as a battery or ultra capacitor. When the variable load 140 spikes, and exceeds the generating capacity of the generator 110, the electrical accumulator unit 150 reverses and begins supplementing the power provided to the DC power bus 130 with the power which has been stored within the power storage component, thereby ensuring that the variable load 140 receives adequate power throughout the high power spike.

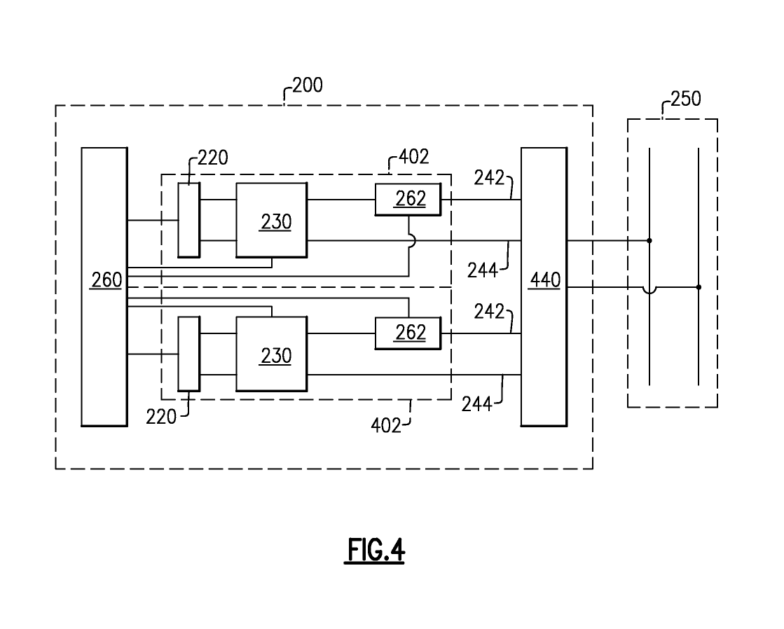

FIG. 3 illustrates a schematic diagram of an example electrical accumulator unit 200. The electrical accumulator unit 200 and power bus 250 represent embodiments of the electrical accumulator unit 150 and DC power bus 130 of FIG. 2. The electrical accumulator unit 200 has multiple stages 202 (also referred to as modules 202), each of which has four primary components, an energy storage unit 220 (also referred to as power storage component 220), a power converter 230, a filter 240, and a power switch 262. Each stage 202 also includes a pair of electrical connectors 242, 244 for connecting the stage 202 to a power bus 250. In the example of FIG. 2, the power switch 262 interrupts one of the electrical connectors 242. Also included is a dedicated electrical accumulator unit controller 260. The controller 260 has an output 264 for controlling each of the power switches 262 and multiple inputs 266, 267, 268 for detecting the states of the energy storage unit 220, the power converter 230 and the filter 240. The controller 260 operates in conjunction with each of the power switches 262, thereby connecting and disconnecting each of the electrical accumulator unit stages 202 as required. The controller 260 allows the multiple stages 202 to be used in conjunction with each other. As illustrated in FIG. 3, each of the electrical accumulator unit stages 202 are connected to the power bus 250 in a parallel arrangement. It is known, however, that alternate connection arrangements could be used with minor modifications to the electrical accumulator unit 200.

The filter 240 is a combination of an input ripple filter and an electromagnetic interference (EMI) filter. The input ripple filter portion of the filter 240 removes ripple currents, which have leaked onto the power bus 250 due to the presence of power electronics in the load, such as variable load 140 of FIG. 2. Similarly, the EMI filter portion of the filter 240 filters out electromagnetic interference present on the power bus 250. Ripple currents and electromagnetic interference are common occurrences in electrical systems and result from the connection the power bus 250 has to the variable load 140 as well as the electrical systems exposure to other sources of electrical noise. Allowing the interference and ripple currents to reach the power converter 230 is undesirable.

After passing through the filter 240, the electrical power enters a bi-directional power converter 230 where it is converted from the form of electrical power used by the power bus 250 into a form which can be accepted and stored by the power storage component 220. The bi-directional power converter 230 is also capable of converting power output from the power storage component 220 into the form used on the power bus 250 when the electrical accumulator unit 200 is providing power to the system, such as during a high load spike or while operating in emergency mode. Furthermore, each of the power converters 230 can be a buck-boost power converter using any known buck-boost circuits. Alternately, the power converters 230 can be a network of parallel phase shifted buck-boost converter circuits, which are configured to operate in conjunction with each other according to known principles.

The power storage component 220 can be any device or component which is capable of accepting power from the power converter 230 and storing that power for later use. In the illustrated example of FIG. 3, a battery or ultra capacitor (ultra cap) could be used. However, other power storage components could be used with minor modifications to the electrical accumulator unit 200. Using multiple stages 202 additionally allows for different energy storage unit types (such as batteries and ultra-capacitors) to be used in each stage 202, thereby allowing for greater optimization of the power and energy capabilities. The controller 260 can additionally isolate a stage 202 with a fault condition or that is otherwise incapacitated, thereby allowing for continued operation of the power generation system 100. Furthermore, the controller 260 allows the modules 202 to be connected in an interleaved manner according to known techniques.

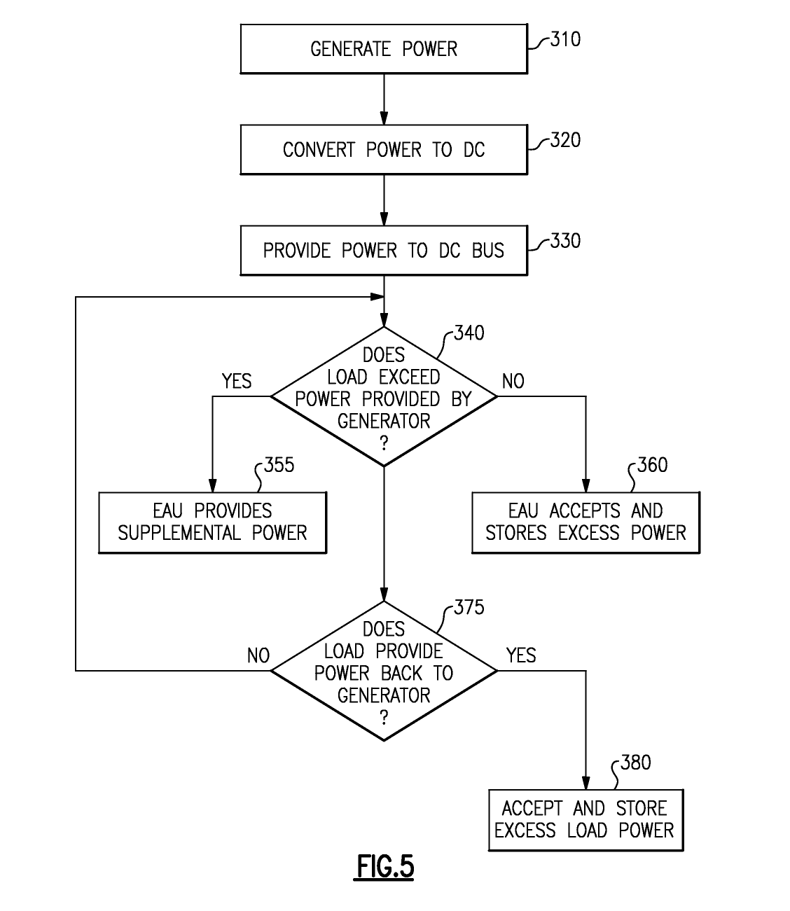

FIG. 4 illustrates an alternate modular electrical accumulator unit 200. In the example of FIG. 4, the filter 240 has been removed from each stage 202, and a single filter 440 that is capable of filtering input power for all of the stages 202 connects each of the modules 202 to the power bus 250. Each of the components 220, 230, 262, 260 and 440 function in a similar fashion as described above with regard to FIG. 3. By moving the filter 440 out of each stage 202, a single more efficient filter 440 can be used, which can allow for a reduction in the weight requirement of the electrical accumulator unit 200.

FIG. 5 illustrates a flowchart of operations of the modular electrical accumulator unit 150, 200 of FIGS. 2 and 3. Initially power is generated by the generator 110 in the “generate power” step 310. After the power has been generated, it is converted into a DC power format used by the DC power bus 130 in the “convert power to DC” step 320, and the power is provided to the DC power bus 130 in the “provide power to DC bus” step 330. Power conversion may be performed by the AC/DC rectifier 120 of FIG. 2. The controller 160 then determines whether the variable load 140 connected to the DC power bus 130 is currently exceeding the amount of power which can be provided by the generator 110 in the “does load exceed power provided by the generator” step 340.

If the variable load 140 exceeds the amount of power which can be generated by the generator 110, the method proceeds to the electrical accumulator unit “provides supplemental power” step 355. In the “provides supplemental power” step 355, a controller for the electrical accumulator unit 150 determines a number of modules required to provide an amount of power equal to the amount by which the variable load 140 exceeds the generation capabilities of the generator 110 and connects an equivalent number of modules 202 to the DC power bus, thereby providing the required power. The power is pulled from the power stored within the power storage component 220 of each connected module 202 of the electrical accumulator unit 150, 200 of FIGS. 2 and 3.

If the variable load 140 does not exceed the amount of power which can be generated by the generator 110, the method moves to the electrical accumulator “accepts and stores excess power” step 360. In this step, the controller 260 detects any modules 202, which are not fully charged and connects them to the DC bus 250, thereby allowing the under charged modules 202 to accept any power generated by the generator 110, which is not required to power the variable load 140. The undercharged modules 202 can be connected to the load using the power switch 262, which is controlled by the electrical accumulator unit controller 260.

While the power demands of variable load 140 are being checked in the “does load exceed power provided by generator” step 340, an additional step may be performed. The “does load provide power back to the generator” step 375 checks to see if the variable load 140 is generating power such that electrical power will be transmitted back through the electrical system to the generator 110. If the variable load 140 is not generating power, the method proceeds as described above. If the variable load 140 is generating power, then the electrical accumulator unit 150 accepts and stores the power generated by the variable load 140 in an “accept and store excess load power” step 380. The “accept and store excess load power” step 380 operates in a similar manner as the “accept and store excess power” step 360.

Optionally, the method can include an additional step where the controller 260 determines if any of the modules 202 are faulty or are otherwise inoperative. If any of the modules are faulty, the controller 260 can disable/disconnect the faulty module until repairs can be made. The presence of multiple electrical accumulator unit modules 202 allows the modular electrical accumulator unit 200 to continue functioning while a portion of the modules 202 are disabled due to faults within the modules 202.

Although an example embodiment has been disclosed, a worker of ordinary skill in this art would recognize that certain modifications would come within the scope of this invention. For that reason, the following claims should be studied to determine the true scope and content of this invention.

1. A modular electrical accumulator unit comprising:
a plurality of electrical accumulator modules, wherein each of said modules comprises:
an energy storage component;
a power converter electrically coupled to said converter;
a pair of electrical connectors for connecting said modules to a power bus;
a power switch capable of isolating said module from said power bus; and
an electrical controller coupled to each of said power switches, thereby allowing said electrical controller to control a connection to the power bus of each of said plurality of modules.

2. The modular electrical accumulator unit of claim 1, wherein said electrical accumulator unit further comprises a power filter for connecting each of said pairs of electrical connectors to the power bus.

3. The modular electrical accumulator unit of claim 1, wherein each of said modules further comprises a power filter connecting said pair of electrical connectors to said power converter.

4. The modular electrical accumulator unit of claim 3, wherein said power filter comprises a ripple filter component and an electromagnetic interference filter component.

5. The modular electrical accumulator unit of claim 3, wherein each of said power converters comprises a buck-boost converter circuit.

6. The modular electrical accumulator unit of claim 5, wherein each of said buck-boost converter circuits comprises a plurality of parallel, phase shifted, buck boost converter circuits configured to operate in conjunction with each other.

7. The modular electrical accumulator unit of claim 3, wherein at least one of said power storage components is a first power storage component type, and wherein at least another of said power storage components is a second power storage component type.

8. The modular electrical accumulator unit of claim 7, wherein at least one of said power storage components comprises an ultra capacitor.

9. The modular electrical accumulator unit of claim 8, wherein at least one of said power storage components comprises a high voltage battery.

10. The modular electrical accumulator unit of claim 3, wherein each of said modules is connected to the power bus in a parallel configuration.

11. The modular electrical accumulator unit of claim 8, wherein each of said modules is interleaved.

12. The modular electrical accumulator unit of claim 3, wherein said controller further comprises electrical couplings to at least one of said power filter, said power converter, and said power storage component in each of said modules.

13. The modular electrical accumulator unit of claim 3, wherein said controller is configured such that each of said modules can be activated and utilized independent of the other modules.

14. The modular electrical accumulator unit of claim 1, wherein said power switch interrupts one of said pair of electrical connections.

15. A method for operating a power system comprising the steps of:
converting said power from a generator into DC power format;
providing said DC power to a DC power bus, said DC power bus providing power to a variable load and to a plurality of electrical accumulator unit modules; and
controlling said plurality of electrical accumulator unit modules using a dedicated electrical accumulator unit controller.

16. The method of claim 15, further comprising the steps of:
determining a number of modules required to provide a needed amount of power; and
connecting a number of charged modules to said DC power bus equal to the number of modules needed, thereby providing additional power to said variable load.

17. The method of claim 15, further comprising the steps of:
detecting a number of fully or partially discharged modules using a controller; and
connecting each of said fully or partially discharged modules to said DC power bus using a power switch controlled by said controller.

18. The method of claim 15, further comprising the steps of:
detecting a faulty module using said controller;
electrically isolating said faulty module using a power switch controlled by said controller, thereby allowing continued operation of said power system.

19. The method of claim 15, further comprising the steps of:
determining if a connected load exceeds a maximum load of a generator;
providing supplemental power to a connected load when said maximum load is exceeded; and
at least a portion of said modules accepting and storing excess power when said maximum load is not exceeded.

20. The method of claim 15, further comprising the steps of:
determining if a connected load is providing power back to a generator; and
at least a portion of said modules accepting and storing power provided by said load.
